(19) United States
(12) Patent Application Publication
(10) Pub. No.: US 2009/0165087 A1
(43) Pub. Date: Jun. 25, 2009

(54) Media registration and validation service to protect against unauthorized media sharing

(76) Inventors: Jacek Jachner, Lexington, MA (US); Maybelline Mamaradlo, Plano, TX (US)

Correspondence Address: Docket Administrator - Room 2F-192;Alcatel-Lucent USA Inc., 600-700 Mountain Avenue, Murray Hill, NJ, 07974, US

(21) Appl. No.: 12/002,887

(22) Filed: Dec. 19, 2007

(51) Int. Cl. H04L 9/32; G06F 17/30; G06Q 10/00; G06Q 30/00

(52) U.S. Cl. 726/2; 707/102; 705/34; 707/5; 705/1; 707/E17.122; 707/E17.014

(57) ABSTRACT

A Media Registration and Validation Service (“MRVS”) facilitates protection against unauthorized media sharing. In the media registration function, the MRVS receives, registers and stores one or more samples of media content defining source content. In the media evaluation function, the MRVS receives samples of media content (“examination content”) submitted for examination relative to the source content. The MRVS searches the database to determine instances of source content corresponding to the examination content, yielding corresponding content; and produces a report including indicia of the corresponding content. Protection against media sharing is thereby accomplished in one aspect by providing notice of registered source content to one or more prospective disclosers of corresponding content (including, without limitation, the submitters of examination content); and in another aspect, the prospective disclosers can rely on the notice to decide whether or not to disseminate their corresponding content.

### BACKGROUND OF THE INVENTION

1. Field of the Invention

This invention relates generally to communications systems and, more particularly, to communications systems and services that protect against unauthorized sharing of multimedia content.

2. Statement of the Problem

Communication systems are well known in which persons may provide and/or access multimedia content. For example, the Internet is a ubiquitous communication system in which multiple users dispersed across multiple geographic areas can contribute or access content including, without limitation, text, audio, video and image content, music descriptive language (e.g., sheet music, midi files) or software (source or object code) via website articles, blogs, message boards, chat rooms or the like; or via certain sites (e.g., YouTube™) that are dedicated to media sharing. Unfortunately, media content promulgated via the internet is largely uncontrolled, or at least inadequately controlled, in terms of protecting against the sharing of copyrighted, proprietary or other unauthorized content. Many websites employ site moderators to review content and remove unauthorized content, but typically site moderators do not have sufficient time and resources to adequately proof all content contributions, postings, and the like for copyrighted or other unauthorized media content. Adding to the difficulty is that media contributions are often received without a copyright notice or any indicia that the contributor has the legal right to disseminate the content.

Consequently, it is not uncommon for copyrighted or unauthorized media content to be improperly posted on the internet, at least until such time that it is discovered and removed by the moderator or website provider. Such unauthorized posting, even for a limited time, can render harm to the copyright holder and/or content owner and may result in legal liability to the contributor and/or the website provider.

### SUMMARY OF THE SOLUTION

This invention solves the above and other problems by providing a Media Registration and Validation Service (“MRVS”) to protect against unauthorized media sharing. Content owners (who may comprise, for example and without limitation, copyright holders, or enterprises wishing to protect proprietary information from general posting or sharing) register and submit a copy of their media with the MRVS. The MRVS stores copies of the media desired to be protected, comprising without limitation, text, audio, video or image content, music descriptive language (e.g., sheet music, midi files) or software (source or object code) in a database (“Do Not Share” database). The MRVS performs a validation service for clients (e.g., website providers) in which prospective content is evaluated against the stored media to determine a likelihood that the content is authorized or unauthorized. The client may rely on the MRVS validation to decide whether or not to disseminate the prospective content via web page posting or other manner; and hence the client is protected against unauthorized media sharing.

### DESCRIPTION OF THE DRAWINGS

FIG. 1 is a block diagram of a Media Registration and Validation Service (“MRVS”) according to an embodiment of the invention;

FIG. 2 is a flowchart showing steps associated with a media registration function implementable by the MRVS according to an embodiment of the invention; and

FIG. 3 is a flowchart showing steps associated with a media validation function implementable by the MRVS according to an embodiment of the invention.

### DETAILED DESCRIPTION OF THE INVENTION

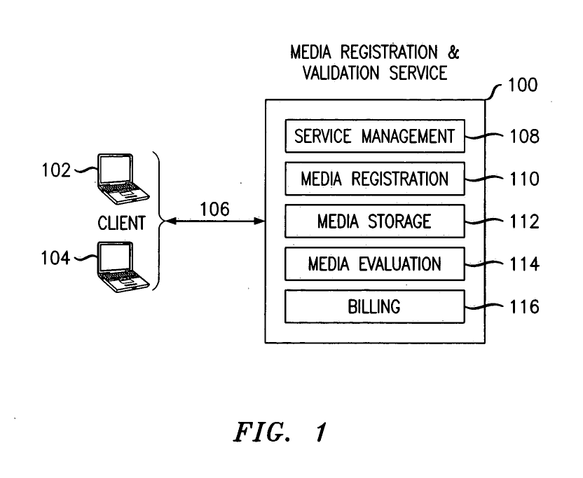

FIGS. 1-3 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a Media Registration and Validation Service (“MRVS”) 100 operable according to principles of the present invention to protect against unauthorized media sharing. Generally, the MRVS 100 is operable to receive, register and store certain media content (“source content”) coincident to a media registration function and to receive and evaluate certain media content (“examination content”) relative to the source content coincident to a media validation function. The source and examination content may include, without limitation, text, audio, video or image content, music descriptive language (e.g., sheet music, midi files) or software (source or object code).

The MRVS 100 receives source content from clients 102 (one shown) comprising, for example and without limitation, copyright holders, or enterprises wishing to protect proprietary information from general posting or sharing; and examination content from clients 104 (one shown) comprising, for example and without limitation, website providers, individuals or enterprises desiring an assessment of the content in advance of disseminating the content and hence provide a degree of protection from legal liability. The MRVS 100 may be implemented in software and/or hardware residing in one or more physical devices including, without limitation, application server(s) of a data network. However, as will be appreciated, the MRVS 100 may be implemented in virtually any network topology. The MRVS 100 receives source and examination content via a client interface 106 comprising any system or software adapted to communicate text, audio, video and/or image content, music descriptive language or software from clients 102 or 104 to MRVS 100 consistent with the network topology.

As shown, the MRVS 100 contains functional elements including: a service management element 108, a media registration element 110, a media storage element 112, a media evaluation element 114 and a billing element 116 adapted to perform respective functions of the MRVS 100 in relation to client services. As will be appreciated, any of several business models (including, for example, a subscription model or pay-per-transaction model) may be utilized for the client services; and the functions of the respective elements may vary depending on the business model.

In one embodiment, the service management 108 element establishes client accounts, maintains records and generates reports associated with clients 102, 104 of the MRVS 100 (including, for example, client IDs, contact information, usage data, service features and/or restrictions) and maps the client IDs to submitted source content and/or examination content. The media registration element 110 operates to receive and register source content (including, without limitation, text, audio, video or images, music descriptive language or software) coincident to the media registration function. The media storage element 112 comprises a database (e.g., a “Do Not Share” database) operable to store registered source content. The media evaluation element 114 operates to receive and evaluate examination content in relation to the stored source content and report a result indicative of the comparison of the examination content to the source content (e.g., an ordered list of closest matches of the source content with the examination content). The billing element 116 performs billing services associated with the MRVS 100 including computation of charges associated with client services based on applicable rates/plans and usage data.

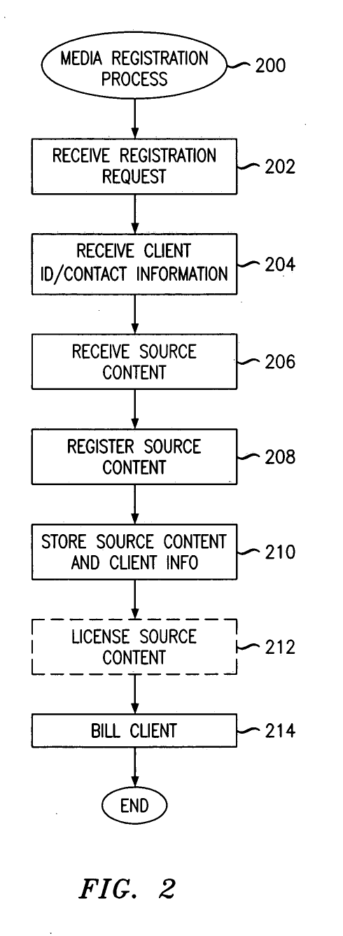

FIG. 2 is a flowchart of a media registration process 200 that can be implemented by the MRVS 100 in an exemplary embodiment of the invention. The steps of FIG. 2 are implemented by the media registration element 110 of the MRVS 100 in cooperation, where applicable, with the service management element 108, media storage element 112 and billing element 116.

At step 202, the media registration element 110 receives a registration request from a client 102 desiring to register source content so as to protect the source content from general posting or sharing. As will be appreciated, depending on implementation of the MRVS 100, the media registration element 110 may receive the registration request from the client directly or indirectly via other elements of the MRVS 100. For example, if the registration request is first received by the service management element 108, it is contemplated that the registration request will be forwarded by the service management element to the media registration element.

At step 204, responsive to the registration request, the media registration element 110 receives identification information associated with the client of the nature needed to accommodate registration. For example, the identification information may include a name/ID of the client and contact/address information. In one embodiment, the media registration element 110 queries the service management element 108 to obtain relevant identification information, which may comprise a subset of the client information maintained by the service management element 108. Alternatively or additionally, the media registration element 110 may receive certain client information directly from the client coincident to the registration request or may query the client for certain client information.

At step 206, the media registration element 110 receives the submitted source content from the client 102 (or alternatively, from another element of the MRVS 100). The submitted source content may comprise, without limitation, text, audio, video, images, music descriptive language (e.g., sheet music, midi files) or software (source or object code). The source content may be copyrighted material, proprietary material or generally any material that the client 102 desires to protect from unauthorized posting or sharing. Optionally, coincident to step 206, the media registration element 110 may prompt the client to provide the source content in a preferred media format, language or the like; or the media registration element may itself convert the submitted format into a preferred media format, language or the like.

At step 208, the media registration element 110 registers the submitted source content, yielding registered content. In one embodiment, registration of source content comprises maintaining a register or record, indexed to client ID, of submitted source content, the type of content and the nature of the content (e.g., indicia of copyrighted material or proprietary material). The content is “registered” in the sense that it is listed in a register maintained by the media registration element 110 for purposes of protecting against unauthorized media sharing. In one embodiment, although the submitted source content may be subject to copyright protection, the media registration process does not include copyright registration; rather, it is contemplated that copyright registration is performed separately by the client in cooperation with the relevant government authority (e.g., the USPTO). Similarly, if the source content comprises a trademark, it is contemplated that trademark registration is obtained by the client in a separate process. As will be appreciated, however, the media registration process 200 may be implemented to facilitate copyright or trademark registration in addition to registration with the media registration element 110.

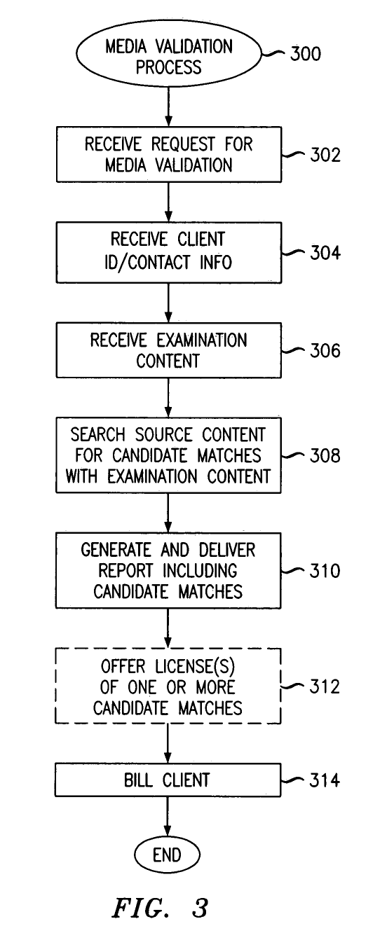

At step 210, the media registration element 110 effects storage of the registered source content, for example, by forwarding the registered source content to the media storage element 112 (e.g., a “Do Not Share” database) operable to store registered source content. As will be described in greater detail in relation to FIG. 3, the database is searchable so that candidate matches can be produced coincident to a media validation function of the MRVS 100.

Optionally, at step 212, the media registration element 110 may facilitate licensing of the source content as an agent for the content owner. A licensing opportunity may arise, for example, responsive to determining that the source content owned by client 102 is a good match with prospective content submitted for validation by a third party client 104 and hence posting or sharing of the prospective content would likely infringe upon the copyright of client 102. In such case, the third party client 104 may wish to obtain a license from the copyright holder client 102 that will permit the client 104 to post or share the prospective content.

At step 214, the billing element 116 performs billing services associated with the media registration process 200. The billing element 116 receives billing information from relevant elements of the MRVS 100 (for example and without limitation, from the service management element 108, media registration element 110 or media storage element 112), computes relevant charges and generates billing statements depending on applicable plans/agreements. As an example, the billing element may charge a flat fee for the media registration process 200 and charge additional fees to facilitate licensing of the source content and/or to facilitate contact with a third party having prospective content that closely matches the source content. Nevertheless, as will be appreciated, the fees can be computed in any of several alternative ways depending on implementation of the MRVS 100 and on the business model.

Now referring to FIG. 3, there is shown a flowchart of a media validation process 300 that can be implemented by the MRVS 100 in an exemplary embodiment of the invention. The steps of FIG. 3 are implemented by the media evaluation element 114 of the MRVS 100 in cooperation, where applicable, with the service management element 108, media registration element 110, media storage element 112 and billing element 116.

At step 302, the media evaluation element 114 receives a media evaluation request from a client 104 desiring an assessment of certain media content (“examination content”) relative to the stored source content to determine, in advance of posting or sharing the examination content, whether such posting or sharing is likely to be authorized or not authorized. As will be appreciated, depending on implementation of the MRVS 100, the media evaluation element 114 may receive the media evaluation request from the client directly or indirectly via other elements of the MRVS 100. For example, if the evaluation request is first received by the service management element 108, it is contemplated that the evaluation request will be forwarded by the service management element to the media evaluation element.

At step 304, responsive to the media evaluation request, the media evaluation element 114 receives identification information associated with the client of the nature needed to accommodate media evaluation. For example, the identification information may include a name/ID of the client and contact/address information. In one embodiment, the media evaluation element 114 queries the service management element 108 to obtain relevant identification information, which may comprise a subset of the client information maintained by the service management element 108. Alternatively or additionally, the media evaluation element 114 may receive certain client information directly from the client coincident to the media evaluation request or may query the client for certain client information.

At step 306, the media evaluation element 114 receives the submitted examination content from the client 104 (or alternatively, from another element of the MRVS 100). The submitted examination content may comprise, without limitation, text, audio, video or images, music descriptive language (e.g., sheet music, midi files) or software (source or object code). Optionally, coincident to step 306, the media evaluation element 114 may prompt the client 104 to provide the examination content in a preferred media format, language or the like; or the media evaluation element may itself convert the submitted format into a preferred media format, language or the like.

At step 308, the media evaluation element 114 searches the stored source content (e.g., the “Do Not Share” database) for candidate matches corresponding to the examination content. As will be appreciated, the manner of search is an implementation detail that will vary depending on the modality (e.g., text, audio, video, images, music descriptive language or software) of the examination and source content. Generally, the search for media content may be conducted using presently known search techniques or those devised in the future for the respective modalities; and may be conducted using data processing applications (e.g., search engines), human evaluation or some combination thereof.

In one exemplary embodiment, a search for candidate matches is accomplished in at least one pass using a data processing application (e.g., search engine) using known search techniques including, without limitation: text-based matching for text media, sound matching for audio media (e.g., speech, tones, music), image matching for images and video matching for video. The search engine may use the registered media or transformations thereof (and similarly, the examination media or transformations thereof) in the interest of increasing search speed, accuracy or in the interest of managing processing resources. For example and without limitation, the search engine may compare fragments of media to find candidate matches. The search results may be refined in consecutive passes using the data processing application and/or human evaluation.

At step 310, the media evaluation element produces a report of the search results for the client 104. As will be appreciated, the report may be communicated to the client in a variety of ways. The report may be communicated directly to the client or the report may be accessible to the client via webpage or the like. In one embodiment, the report comprises an ordered list of one or more candidate matches (i.e., listed in order of perceived nearest matches) viewable via webpage, application software or the like (defining a “list view”), and including url links, menu options or other suitable user interface that enable the client to review the candidate matches in greater detail. With assistance of such review, the client 104 can make an educated assessment of whether its examination content is authorized to be posted or disseminated. Optionally, to further assist the client 104 to assess the authorization status of the submitted content, the report may include a “score” or probability assessment associated with one or more candidate matches. Still further, the report may optionally include identification and/or contact information associated with the content owner(s) of the candidate matches, which information may be useful in case the client 104 may wish to pursue a license of any of the candidate matches. Optionally, at step 312, the media evaluation element 114 may facilitate licensing of the candidate matches.

As still another option, the media evaluation element may forward the examination content to the media registration element 110; and the media registration element can effect registration and storage of the submitted examination content such as described in relation to FIG. 2. In such manner, the examination content can become registered source content for later iterations of the media validation process 300 and can possibly become a candidate match for later-submitted examination content.

At step 314, the billing element 116 performs billing services associated with the media validation process 300. The billing element 116 receives billing information from relevant elements of the MRVS 100 (for example and without limitation, from the service management element 108 or media evaluation element 114), computes relevant charges and generates billing statements depending on applicable plans/agreements. As an example, the billing element may charge a flat fee or transaction fee for performing the media validation process 300 and/or media registration process 200 responsive to submissions of examination content. As another example, the billing element may charge additional fees to owners of source content if their content is found to be a close match to submitted examination content or to facilitate licensing of the source content. Nevertheless, as will be appreciated, the fees can be computed in any of several alternative ways depending on implementation of the MRVS 100 and on the business model.

The present disclosure has therefore identified a Media Registration and Validation Service (“MRVS”) 100 operable to protect against unauthorized media sharing by performing a media registration process 200 and media validation process 300. It should be understood that the steps of the methods set forth herein are not necessarily required to be performed in the order described, additional steps may be included in such methods, and certain steps may be omitted or combined in methods consistent with various embodiments of the present invention.

The present invention can be embodied in the form of methods and apparatuses for practicing those methods. The present invention can also be embodied in the form of program code embodied in tangible media, such as USB flash drives, CD-ROMs, hard drives or any other machine-readable storage medium, wherein, when the program code is loaded into and executed by a machine, such as a computer or processor, the machine becomes an apparatus for practicing the invention. The present invention can also be embodied in the form of program code, for example, whether stored in a storage medium, loaded into and/or executed by a machine or transmitted over some transmission medium or carrier, such as over electrical wiring or cabling, through fiber optics, or via electromagnetic radiation, wherein, when the program is loaded into and executed by a machine, such as a computer, the machine becomes an apparatus for practicing the invention.

While this invention has been described with reference to illustrative embodiments, the invention is not limited to the described embodiments but may be embodied in other specific forms without departing from its spirit or essential characteristics. The scope of the invention is, therefore, indicated by the appended claims rather than by the foregoing description. All changes that come within the meaning and range of equivalency of the claims are to be embraced within their scope.

I claim:

1. A media registration and validation system comprising:
a media registration element operable to receive and register media content submitted by one or more clients for protection against unauthorized media sharing, the media content received by the media registration element defining source content and registration of the source content yielding registered source content;
a media storage element operable to store the registered source content;
a media evaluation element operable to evaluate certain media content relative to the source content, the media content evaluated by the media evaluation element defining examination content.

2. The system of claim 1, wherein the source content comprises one or more of text, audio, video content, image content, music descriptive language content and software content.

3. The system of claim 1, wherein the examination content comprises one or more of text, audio, video content, image content, music descriptive language content and software content.

4. The system of claim 1, wherein the media evaluation element is operable responsive to evaluating the examination content to produce a report including a list of candidate matches of the source content relative to the examination content.

5. The system of claim 1, further comprising a service management element operable to establish and maintain client accounts associated with operation of the media registration and validation system.

6. The system of claim 1, further comprising a billing element operable to perform billing services associated with operation of the media registration and validation system.

7. A method comprising:
receiving one or more samples of media content defining source content, the source content submitted for protection against unauthorized media sharing;
registering the source content, yielding registered source content;
providing notice indicating a registration status of at least one or more selected items of the registered source content to one or more prospective unauthorized disclosers of corresponding media content, thereby facilitating protection of the at least one or more selected items against unauthorized media sharing.

8. The method of claim 7, wherein the step of receiving source content comprises receiving one or more of text, audio, video content, image content, music descriptive language content and software content.

9. The method of claim 7, wherein the step of providing notice is accomplished coincident to determining at least one instance wherein an item of registered source content is subject to prospective disclosure from an unauthorized third party.

10. The method of claim 7, further comprising storing copies of the registered source content in a database.

11. The method of claim 10, further comprising:
receiving samples of media content defining examination content from one or more prospective disclosers of the examination content; and
searching the database to determine one or more instances of registered source content corresponding to the examination content, yielding corresponding registered content;
the step of providing notice comprising informing the prospective disclosers of the one or more instances of corresponding registered content, thereby facilitating protection of the corresponding registered content against unauthorized media sharing.

12. The method of claim 11, wherein the step of providing notice comprises providing an ordered list of a plurality of instances of registered source content corresponding to the examination content.

13. The method of claim 11, wherein the corresponding registered content includes one or more items subject to copyright protection, the step of providing notice comprises providing an assessment characterizing the likelihood of the examination content infringing the copyright of any of the one or more items.

14. The method of claim 11, wherein the step of providing notice further comprises providing contact information associated with one or more owners of the corresponding registered content.

15. A method comprising:
maintaining a database including one or more samples of source content, the source content comprising one or more of text, audio, video content, image content, music descriptive language content, and software content;
receiving samples of media content submitted for examination relative to the source content, the samples defining examination content;
searching the database to determine instances of source content corresponding to the examination content, yielding corresponding content; and
producing a report including indicia of the corresponding content.

16. The method of claim 15, further comprising communicating the report to one or more prospective disclosers of the examination content.

17. The method of claim 15, wherein the step of producing a report comprises producing an ordered list of source content corresponding to the examination content.

18. The method of claim 15, wherein the corresponding content includes one or more items subject to copyright protection, the step of producing a report comprises providing an assessment characterizing the likelihood of the examination content infringing the copyright of any of the one or more items.
